(19) United States
(12) Patent Application Publication
(10) Pub. No.: US 2002/0078466 A1
(43) Pub. Date: Jun. 20, 2002

(54) System and method for enhanced video e-mail transmission

(75) Inventor: William J. Beyda, Cupertino, CA (US)

Correspondence Address: Siemens Corporation, Attn: Elsa Keller, Legal Administrator, Intellectual Property Department, 186 Wood Avenue South, Iselin, NJ, 08830, US

(73) Assignee: Siemens Information and Communication Networks, Inc.

(21) Appl. No.: 09/738,801

(22) Filed: Dec. 15, 2000

(51) Int. Cl. G06F 3/00; H04N 5/445; G06F 13/00; H04N 7/173

(52) U.S. Cl. 725/109; 725/110; 725/51

(57) ABSTRACT

An improved video e-mail system includes a video input device with a video e-mail controller, and a Web Access Device processor implementing video capture, e-mail and compression selection programs. In operation, a user activates the video e-mail controller, for example, by pushing or clicking a button. The video input device sends a video stream to the Web Access Device processor which is stored until the user clicks or pushes the button again. The Web Access Device processor then activates the e-mail program, opens a “compose” window, and attaches the stored video file.

### BACKGROUND OF THE INVENTION

1. Field of the Invention

The present invention relates to telecommunications systems, and in particular, to an improved system and method for transmitting video clips as e-mail attachments.

2. Description of the Related Art

It is increasingly desirable to send video clips as e-mail attachments. When the video clip is already stored as a file, the process is relatively straightforward: the user opens an e-mail program and creates a message, finds the file in the appropriate directory, and then clicks to add the video file as an attachment. Even this level of complexity, however, has been known to test the limits of the abilities of the casual user.

If the clip needs to be created, the user must also undertake a process of “capturing” the clip to a file, saving it to a known directory, and then attaching it as described above. However, this level of user input is often inconvenient and also in certain instances, beyond the user's ability.

While certain scanners provide a one step process wherein a document is scanned and attached to an outgoing e-mail in a single step, this approach is not necessarily feasible with a video clip which has a start and an end.

As such, there is a need for a system which simplifies the process of acquiring and attaching video files to e-mails.

### SUMMARY OF THE INVENTION

These and other drawbacks in the prior art are overcome in large part by a system and method according to the present invention. An improved video e-mail system includes a video input device with a video e-mail controller, and a Web Access Device processor implementing video capture, e-mail and compression selection programs. In operation, a user activates the video e-mail controller, for example, by pushing or clicking a button. The video input device sends a video stream to the Web Access Device processor which is stored until the user clicks or pushes the button again. The Web Access Device processor then activates the e-mail program, opens a “compose” window, and attaches the stored video file.

### BRIEF DESCRIPTION OF THE DRAWINGS

A better understanding of the invention is obtained when the following detailed description is considered in conjunction with the following drawings in which:

FIG. 1 is a diagram illustrating a telecommunications system according to an embodiment of the invention;

FIG. 2 is a diagram illustrating an exemplary e-mail and video system according to an implementation of the invention;

FIG. 3 is a block diagram illustrating an exemplary video controller according to an implementation of the invention;

FIG. 4 is a block diagram of an exemplary computer implementing software modules according to an implementation of the invention;

FIG. 5 is a block diagram of a video and e-mail system according to another implementation of the invention;

FIG. 6 is a flowchart illustrating operation of an embodiment of the invention; and

FIG. 7 is a flowchart illustrating operation of an embodiment of the invention.

### DETAILED DESCRIPTION OF THE INVENTION

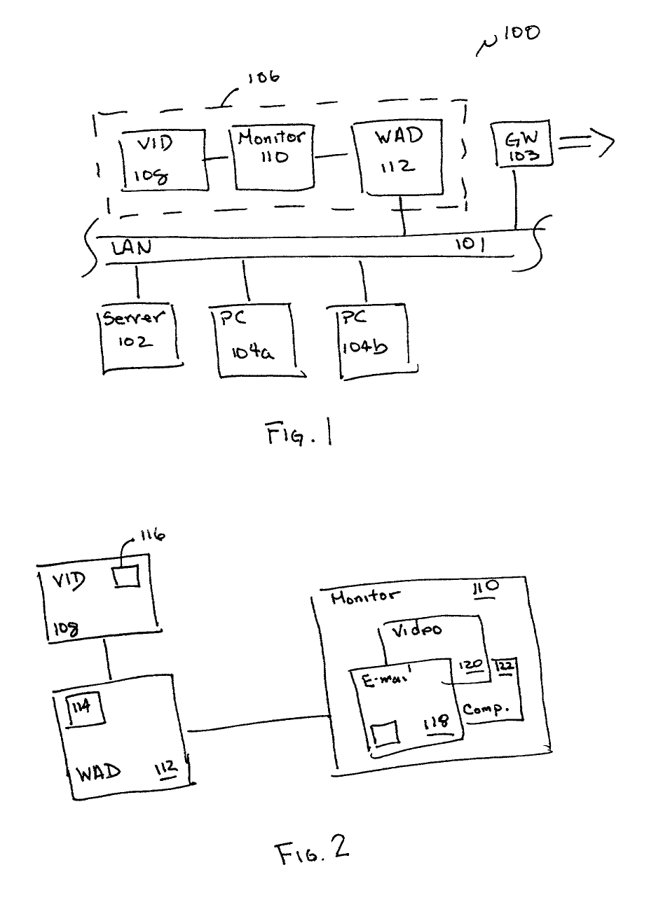

FIGS. 1-7 illustrate an enhanced video e-mail transmission system and method according to various implementations of the present invention. An improved video e-mail system includes a video input device with a video e-mail controller, and a Web Access Device processor implementing video capture, e-mail and compression selection programs. In operation, a user activates the video e-mail controller, for example, by pushing or clicking a button. The video input device sends a video stream to the Web Access Device processor which is stored until the user clicks or pushes the button again. The Web Access Device processor then activates the e-mail program, opens a “compose” window, and attaches the stored video file. This system is particularly suited for an in room presentation system, when it is desired to send to interested parties a clip that has been displayed on a projector. Moreover, the present invention allows relatively simple transmission of video clips during the course of a teleconference, if a video conference is not available.

Turning now to the drawings and with particular attention to FIG. 1, a telecommunications system 100 according to an embodiment of the present invention is shown. In particular, according to the implementation illustrated, the telecommunications system 100 includes a local area network (LAN) or packet network 101. Coupled to the LAN 101 may be a server 102, a gateway 103, one or more network devices 104a, 104b, such as personal computers, and a video e-mail system 106. The telecommunications system 100 may be implemented, for example, as an H.323 compatible, or other standard multimedia network system.

The video e-mail system 106 includes a video input device 108, a monitor 110, and a web access device 112, such as a personal computer. The video input device 108 may be implemented as any device capable of generating a video, such as a video cassette recorder, a digital video disk player, video camera, a stand alone television or tuner card, or a TiVo device. The video input device 108 is operable to play videos for display on the monitor 110 which may be a television monitor, or the computer monitor of the web access device 112 (not shown). The web access device 112 may be implemented as any device capable of sending e-mail and attachments, such as an Internet capable personal computer or WebTV appliance. Further, while shown attached to a LAN, the web access device may be implemented as a stand alone unit, coupling for example, to the Internet via a dial up connection.

As will be described in greater detail below, the video input device 108 is adapted to provide a video clip to the web access device 112 for transmission as e-mail, either to a PC 104a, 104b on the LAN 101, or via the gateway 103 to devices external to the network 101.

More particularly, an exemplary video e-mail system 106 is illustrated in greater detail in FIG. 2. As shown, the video e-mail system 106 includes a video input device 108, a monitor 110, and a Web Access device 112. As noted above, the video input device 108 may be implemented as a DVD player, a VCR, a TV, camera, or a TiVo device. The monitor 110 may be a television monitor or a PC monitor. Finally, the Web Access device 112 may be implemented as a personal computer.

The Web Access Device 112 includes a Web Access Device processor 114 that supervises system operation. The Web Access device processor 114 may be an x86 type or compatible processor. As illustrated, the video input device 108 includes a video e-mail control input 116. The video e-mail control input 116 may be implemented as a physical button, or switch. Alternatively, the video e-mail control 116 may be implemented as a clickable icon on a graphical user interface displayed on the monitor 110 or as a remote control button.

The monitor 110 may be adapted to display an interface for e-mail program 118, executable by the processor 114, as will be described in greater detail below. Further, if the Web Access Device 112 is itself equipped with a video card (not shown), the monitor 110 may include a video window 120 for display of television or other video inputs. Otherwise, a separate television may be coupled to the video input device 108. One implementation of the invention further includes a compression selection dialog 122 for selecting video compression, as will be described in greater detail below.

In operation, the video input device 108 is used to generate video images for display on the video screen 120. A user may click the button 116 to activate the video e-mail feature. In response, the video input device 108 sends a start of clip signal to the Web Access Device 112. This identifies to the Web Access Device the start of the video clip that is to be e-mailed. The video input device 108 then transmits the video signal to the Web Access Device 112, which is stored in a default location. Upon a subsequent clicking of the button 116, an end of clip signal is transmitted to the Web Access Device 108, letting the Web Access Device know that the clip is finished. In alternate embodiments, a second click on the button 116 is unnecessary. A predetermined default length of clip, such as ten (10) seconds, may be programmed in. In still another implementation, a dialog window may be provided for the user to set a predetermined time interval.

Once the clip is stored, the Web Access Device processor 114 activates the e-mail program and opens the e-mail window 118. The e-mail program may be any suitable e-mail program, such as Netscape Mail, Microsoft Outlook or the like. The e-mail window 118 may be representative of a “Compose E-mail” window. The clip is then attached to the compose message as an e-mail attachment. The user then fills in the message and the address and sends the message to the Internet or LAN. Prior to attaching the clip, the user may be presented with the option of the selecting the video format of the transmitted attachment. Otherwise, a predetermined default may be used.

FIG. 3 is a block diagram illustrating the video input device 108 in greater detail. As shown, the video input device 108 includes a video control unit 302 and is coupled to receive signals from the video e-mail control 116. The video control 302 includes a variety of video input/output lines 304 for communication with, for example, the monitor 110 and/or the web access device 112. The video control 302 may be any suitable any suitable video and control chipsets to implement TiVo, DVD, VCR, or TV functionality.

As noted above, the video e-mail control 116 may be implemented as a physical switch, a remote switch, or as a clickable icon on the video screen. The signal is received at the video control unit 302, which then sends a start of clip signal to the web access device 112. The video control 302 may be equipped with a timer (not shown) to time a predetermined clip length. When the timer expires, the video control 302 will send an end of clip signal to the web access device. Otherwise, the signal will be sent responsive to receiving another input from the video e-mail control 116.

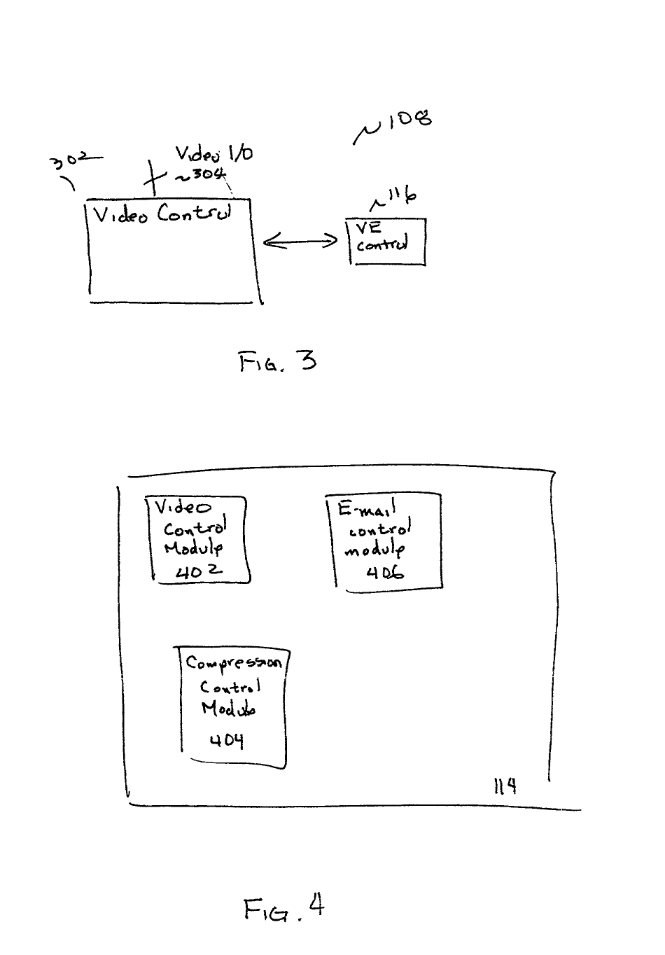

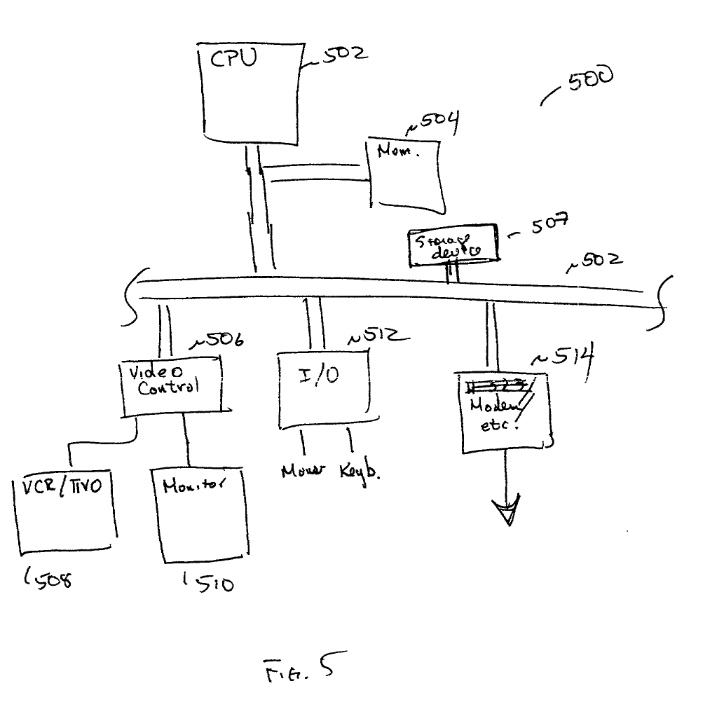

FIG. 4 is a block diagram illustrating the web access device 112. More particularly, FIG. 4 illustrates the various software modules implemented by the processor 114 and associated support and memory chips (not shown). The web access device 112 implements a video control module 402, a compression control module 404, and an e-mail control module 406. The video control module 402 supervises reception and storage of the video clip. The video control module is responsive to the start of clip and end of clip signals from the video input device 108. The compression control module 404 selects a type of compression for the video clip. For example, when the clip is initially stored in memory (not shown), it is stored in a predetermined format, such as MPEG, AVI, RM, or the like. The compression control module 404 allows the user to set, via appropriate GUI (not shown) controls, the type of compression to be used in the attached clip (e.g., MPEG, or whether it is “zipped”). The compression may be preset or may be set manually for each attachment. Finally, the e-mail control module 406 activates and controls operation of the e-mail functionality.

Turning now to FIG. 5, a block diagram of another implementation of a video e-mail system is shown. The video e-mail system 500 of FIG. 5 is implemented as a computer with built-in video e-mail capabilities. The system 500 includes a processor 502, a memory 504, and a system bus 502, such as a PCI bus. Coupled to the bus 502 are a video control unit 506, a storage device 507, an I/O unit 512, and a network control unit, such as a modem or network interface card 514.

The I/O control unit 512 interfaces to a keyboard and mouse (not shown) for receiving user input. The video controller 506 interfaces to a video device 508 and a monitor 510. The video device 508 may be a video recorder, such as a video cassette recorder, a TiVo device, a television tuner card, or DVD controller. The video inputs are displayed on the monitor 510.

Operation is generally similar to that described above with reference to the implementation of FIG. 1. The video input device 508 provides a video signal that is displayed on the monitor 510. When the user clicks on either a physical switch on the video input device or a remote control, or a clickable button viewable on the monitor 510, a start of clip signal is transmitted, and the clip begins to be captured and stored in the storage device 507. Either a timed predetermined time later or upon another button click, the end of clip is identified and the storage of the clip is complete. The processor 502 then activates the e-mail program and displays a “compose” window on the screen of the monitor 510. The clip is then attached to the composed e-mail. A compression option may be provided via a graphical user interface (not shown), allowing the user the ability to select the degree or type of compression.

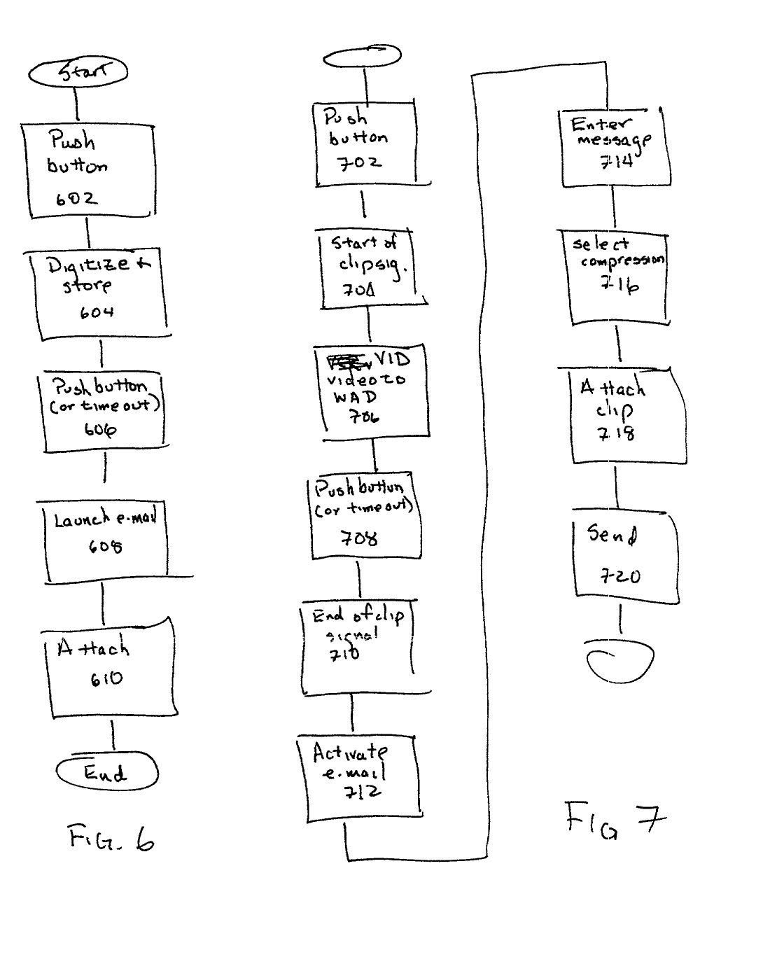

Operation of the present invention is shown in more detail with reference to the flowchart of FIG. 6. In a step 602, a user pushes a physical switch, remote control button, or a GUI button to activate the video e-mail attachment process. In a step 604, the video is digitized and stored in a mass storage device. Next, the clip ends, either in response to another click of the button or a predetermined time period after. In a step 608, the e-mail application program is launched and a “Compose” window is opened. The saved clip is then attached to the open file in a step 610.

FIG. 7 is a flowchart illustrating operation of another implementation of the present invention. In a step 702, the video e-mail button is clicked or switched on. As noted above, this may be either a physical switch associated with the video input device, a remote control button, or a clickable button on a graphical user interface. In a step 704, the video input device sends a “start of clip” message to the web access device identifying the start of the clip. In a step 706, the video input device sends its signal to the web access device. In a step 708, the user again clicks the video e-mail button and in step 710, the video input device sends the end clip command to the web access device. In an alternate embodiment, the second activation of the video e-mail button is unnecessary. The clip will simply end after a predetermined period elapses. In a step 712, the web access device processor activates the e-mail program, displaying an e-mail compose window. In a step 714, the user can enter a message, including an address, select encryption, and any desired text or e-mail option. In a step 716, the user can select a type of compression to be applied. For example, this can include use of a separate GUI or compression wizard to step the user through the process. Alternatively, the compression applied is a predetermined default. In a step 718, the video clip is attached to the compose e-mail message. Finally, in a step 720, the e-mail with the attached video is sent out to the desired recipients.

The invention described in the above detailed description is not intended to be limited to the specific form set forth herein, but is; intended to cover such alternatives, modifications and equivalents as can reasonably be included within the spirit and scope of the appended claims.

What is claimed is:

1. A method, comprising:
playing a video on a video input device;
receiving an activate signal;
digitizing and storing at least a portion of said video;
receiving a deactivate signal;
compressing said at least a portion of said video;
storing said at least a portion of said video;
launching an e-mail application; and
attaching said at least a portion of said video to an e-mail message.

2. A method in accordance with claim 1, wherein said compressing further comprises a user selecting a compression method.

3. A method in accordance with claim 1, wherein said receiving a deactivate signal is responsive to a timeout of a timer.

4. A telecommunications device, comprising:
a video input device for generating video images;
a monitor for displaying said video images; and
a Web Access device including an e-mail module, said Web Access device adapted to receive video images from said video input device and automatically attached said video images to an e-mail responsive to a video e-mail command signal.

5. A telecommunications device in accordance with claim 4, said video e-mail command signal comprising a signal from a switch associated with said video input device.

6. A telecommunications device in accordance with claim 4, said video e-mail command signal comprising a signal from a remote control switch associated with said video input device.

7. A telecommunications device in accordance with claim 4, said video e-mail command signal comprising a signal from a graphical user interface.

8. A telecommunications device according to claim 4, wherein said monitor is a television screen.

9. A telecommunications device according to claim 8, wherein said Web Access Device comprises a personal computer.

10. A method, comprising:
providing a video input device for generating video images;
providing a monitor for displaying said video images; and
providing a Web Access device including an e-mail module, said Web Access device adapted to receive video images from said video input device and automatically attached said video images to an e-mail responsive to a video e-mail command signal.

11. A method in accordance with claim 10, said video e-mail command signal comprising a signal from a switch associated with said video input device.

12. A method in accordance with claim 10, said video e-mail command signal comprising a signal from a remote control.

13. A telecommunications device in accordance with claim 10, said video e-mail command signal comprising a signal from a button associated with a graphical user interface.

14. A method in accordance with claim 1 0, wherein said monitor is a television screen.

15. A method in accordance with claim 10, wherein said Web Access Device comprises a personal computer.

16. A telecommunications system, comprising:
a local area network; and
a video e-mail system coupled to said local area network, the video e-mail system including:
a video input device for generating video images;
a monitor for displaying said video images; and
a Web Access device including an e-mail module, said Web Access device adapted to receive video images from said video input device and automatically attached said video images to an e-mail responsive to a video e-mail command signal.

17. A telecommunications device in accordance with claim 16, wherein said e-mail comprises an e-mail for another entity on said LAN.

18. A telecommunications device in accordance with claim 16, wherein said e-mail comprises an e-mail for an entity external said LAN.
